(19) United States
(12) Patent Application Publication
(10) Pub. No.: US 2017/0088309 A1
(43) Pub. Date: Mar. 30, 2017

(54) PALLET AND METHOD OF MAKING A PALLET

(71) Applicant: Achiman Pty Ltd, New South Wales (AU)

(72) Inventors: Nick Tandy, New South Wales (AU); Steve Hill, New South Wales (AU); Craig Ruby, New South Wales (AU); Chris Hill, New South Wales (AU); David Shoolman, New South Wales (AU); Lee Baker, New South Wales (AU); Mark Bayly, New South Wales (AU)

(21) Appl. No.: 15/312,566

(22) PCT Filed: May 22, 2015
(86) PCT No.: PCT/AU2015/050270

§ 371 Date: Nov. 18, 2016

(30) Foreign Application Priority Data
May 22, 2014 (AU) 2014901932
Dec. 1, 2014 (AU) 2014904865

(51) Int. Cl. B65D 19/00; B29C 69/00; B29C 45/16

(52) U.S. Cl. CPC B65D 19/001; B29C 45/16; B29C 69/00; B65D 2519/00034; B65D 2519/00069; B65D 2519/00139; B65D 2519/00273; B65D 2519/00288; B65D 2519/00318; B65D 2519/00333; B65D 2519/00442; B65D 2519/00562; B29K 2055/02

(57) ABSTRACT

A method of making a pallet (10, 210) includes providing a pallet inner core (16, 218), and attaching, by adhesive, first and second complementarily shaped plastic skin shells (12, 14, 226) to portions of the core, and interconnecting the shells by heat fusing or interlocking elements. Each shells is formed of two plastic materials. The core is formed with reinforcing truss beams (700) therein, each having an upper chord part (710) which is flush with an upper surface of the core and in contact with the upper shell or adhesive. Each beam has webs (708) connected to chords, straight central portions (702) and end portions (704) extending downwardly into leg portions of the pallet. Also disclosed is a pallet having such features.

### FIELD OF THE INVENTION

This invention relates to a pallet, and to a method of forming a pallet.

### BACKGROUND TO THE INVENTION

Traditional wooden pallets have often had suitable strength characteristics for the loads that they have supported. However, wooden pallets are relatively heavy, thereby contributing to the combined weight of the pallets and the loads supported on the pallets. This can be especially disadvantageous in circumstances where heavier weights can contribute to transport costs, such as in the case of air transport.

Another disadvantage of wooden pallets is that they are susceptible to accumulation of dirt and contamination. This is especially detrimental in circumstances where cleanliness and the preserving of hygiene are important with respect to the goods to be transported on the pallets—for example goods in the nature of foods.

There are known pallets of other materials such as plastics. Plastics materials have the potential advantage of being lighter than wood, and easier to keep clean and hygienic. However, a common disadvantage of pallets of plastics materials is that they lack the strength and durability characteristics of wooden pallets.

This is especially problematic when the pallets are supported on pallet drive through racking with portions of the pallets spanning areas between the racks. Because of the lack of sufficient strength, such pallets can become downwardly bowed or can sag and this can reduce the functional life of the pallets and can result in damage to the supported goods.

In addition, existing plastic pallets often have slippery surfaces, which is due to the inherent nature of the plastics materials that have traditionally been used for this purpose.

A known type of pallet includes plastics reinforcement bars for contributing to the strength of the pallet. However, such reinforcement bars are typically positioned so as to be an obstacle to pallet trucks that are used to lift and move such a pallet, especially near a lower extremity of the pallet.

Indeed, as the wheels below the tines of the pallet trucks are usually of relatively small diameter, the wheels do not easily ride over the reinforcement bars, and attempts to move the tines under the pallets often causes the wheels to push the pallets along the ground on which they are supported.

In addition, reinforcement bars have themselves often lacked sufficient strength and have therefore suffered undesirable amounts of flexing with resultant flexing and sagging of the pallets as a whole.

Another disadvantage of such pallets is that they are soft when compared with wooden pallets, and the tines of pallet trucks or forklift trucks, if not properly aligned with the pallets, can penetrate and damage the support portions of the pallets.

Certain known plastic pallets are made from High-density polyethylene (HDPE) using an injection moulding process. While such pallets are usually strong and robust which can contribute to a long pallet life, such pallets have disadvantages in practical use, for example in warehouses and during transport; because of the relatively slippery nature of the plastics used, loads tend to slide undesirably on the pallet decks and slip off the decks. In addition, the pallets themselves tend to undesirably slip and slide on the metal runners on which the pallets are typically placed in automated warehouse environments. As a result, the pallets give rise to danger of injury to personnel working in these environments, and damage to palleted goods, and can negatively impact on the operation times involved in loading, storing and moving pallets.

In addition, while different types of plastics are suitable for meeting different desirable characteristics for pallets, such as durability, robustness, slip-resistance properties, suitability for use with food products, suitability for use in environments with wide ranges of temperatures, etc, known pallets have not met a suitable number of such requirements.

Another problem relates to certain known or experimental pallets that have made use of plastic skins applied to pallet cores, for example by thermoforming. When the skins have been applied to the cores, walls of the skins have become undesirably thin over many important areas of the pallets including the pallet legs. The legs are typically the areas most likely to be impacted by the tines of forklift or similar vehicles used to lift the pallets, thus making the legs prone to being punctured. This can significantly reduce the life span, robustness, and effectiveness of the pallets.

It is an object of the present invention to ameliorate the above and other disadvantages of the prior art, or to provide a useful alternative thereto.

### SUMMARY OF THE INVENTION

ACCORDING TO A FIRST ASPECT OF THE INVENTION there is provided a method of making a pallet having a load support surface, the method including:
providing a pallet inner core having a predetermined outer shape, the core including a load support face;
providing a first shell component of plastics material, at least part of the first shell component having a shape substantially complementary to a first portion of said outer shape;
providing a second shell component of plastics material, at least part of the second shell component having a shape substantially complementary to a second portion of said outer shape;
disposing the first shell component on said core such that the first shell component complementarily fits onto said first portion;
disposing the second shell component on said core such that the second shell component complementarily fits onto said second portion; and
interconnecting the first and second shell components to each other,
wherein a load support part of the outer surface of one of the shell components constitutes said load support surface of the pallet, and extends over said load support face of the core.

In a preferred embodiment, the step of forming a pallet includes applying an adhesive to at least one of the shell and the core before disposing that shell component on the core.

Preferably, the adhesive is a polyurethane adhesive.

In a preferred embodiment, the steps of disposing the first and second shell components includes causing one of the shell components to overlap the other of the shell components.

Then, preferably, the step of interconnecting the first and second shell components to each other includes fusing the overlapping parts of the shells to each other.

In another preferred embodiment, the step of interconnecting the first and second shell components to each other includes engaging locking formations of one of the shell components with locking formations of the other of the shell components.

In a preferred embodiment, the method includes forcing the shell components onto the core.

Then, according to one preferred embodiment, the step of forcing the shell components onto the core includes placing the combined shell components and core in an envelope and drawing air from the envelope.

According to another embodiment, the step of forcing the shell components onto the core includes applying pressure using a press apparatus.

In a preferred embodiment, the steps of providing the first and second shell components include providing said shell components with each shell component being of a first plastics material and a second, different plastics material joined to the first plastics material.

Then, preferably, the steps of providing the first and second shell components include co-injection moulding each of the shell components with both of said first and second plastics materials.

Preferably, the first plastics material is Thermoplastic polyurethane (TPU) plastic and the second plastics material is Acrylonitrile butadiene styrene (ABS) plastic, wherein the first plastics material forms an outer surface of each shell component. In this case, preferably, the thickness of the first plastics material is 15% of the combined thickness of the first and second plastics materials and the thickness of the second plastics material is 85% of said combined thickness.

In a preferred embodiment, the step of providing the inner core includes forming the core by moulding.

Then, preferably, the step of forming the core includes forming the core with a plurality of reinforcement beams within the core.

In a preferred embodiment, in the step of forming the core with a plurality of reinforcement beams within the core, each of the beams is of one of HIPS plastic, ABS plastic, and aluminium.

Then preferably, the step of forming the core includes forming the core with an upper edge of each beam flush with said load support face of the core such that, when the particular shell component that includes said load support part is disposed on the core, the upper edge of each beam is in contact with at least one of said particular shell component and adhesive between said particular shell component and the core.

In a preferred embodiment, in the step of forming the core with a plurality of reinforcement beams, each beam is in the form of a truss having an outer frame member constituting upper and lower chords of the truss, and web elements integrally joined to the frame member.

Preferably, the web elements and outer frame member define a plurality of substantially triangular apertures.

Preferably, the material of which the core is formed extends through the apertures.

Preferably, in the step of forming the core with a plurality of reinforcement beams, each beam has an operational position and includes a central span portion having an upper chord and two end portions extending away from said upper chord.

In a preferred embodiment, the method is for forming a pallet having a pallet operational position and a load support platform which includes said load support surface, for supporting a load when the pallet is in said pallet operational position, and two side leg portions extending downwards relative to the load support platform when the pallet is in the pallet operational position, wherein, in the step of providing the core, the core includes a platform portion and side leg portions which are complementary to the load support platform and leg portions of the pallet respectively, wherein in the step of forming the core with a plurality of reinforcement beams, the end portion of each beam extends into a respective one of the side leg portions of the core.

ACCORDING TO A SECOND ASPECT OF THE INVENTION there is provided a pallet having a load support surface, the pallet including:
a pallet inner core having an outer shape, the core including a load support face;
a first shell component of plastics material, at least part of the first shell component having a shape substantially complementary to a first portion of said outer shape;
a second shell component of plastics material, at least part of the second shell component having a shape substantially complementary to a second portion of said outer shape;
the first shell component being disposed on said core such that the first shell component complementarily fits onto said first portion;
the second shell component being disposed on said core such that the second shell component complementarily fits onto said second portion; and
the first and second shell components are interconnected to each other,
wherein a load support part of the outer surface of one of the shell components constitutes said load support surface of the pallet, and extends over said load support face of the core.

In a preferred embodiment, an adhesive is provided between at least one of the shell components and the core.

Preferably, the adhesive is a polyurethane adhesive.

In a preferred embodiment, one of the shell components overlaps the other of the shell components.

Then, preferably, the overlapping parts of the shells are fused to each other.

In another preferred embodiment, each of the first and second shell components includes locking formations, the locking formations of one of the shell components being engaged with locking formations of the other of the shell components.

In a preferred embodiment, each shell component is of a first plastics material and a second, different plastics material joined to the first plastics material.

Then, preferably, each of the shell components has been co-injection moulded with both of said first and second plastics materials.

Preferably, the first plastics material is Thermoplastic polyurethane (TPU) plastic and the second plastics material is Acrylonitrile butadiene styrene (ABS) plastic, wherein the first plastics material forms an outer surface of each shell component. Then, preferably, the thickness of the first plastics material is 15% of the combined thickness of the first and second plastics materials and the thickness of the second plastics material is 85% of said combined thickness.

In a preferred embodiment, the pallet includes a plurality of reinforcement beams within the core.

Each of the beams is preferably of one of HIPS plastic, ABS plastic, and aluminium.

Then preferably, an upper edge of each beam is flush with said load support face of the core such that the upper edge of each beam is in contact with at least one of the particular shell component that includes said load support part and adhesive between said particular shell component and the core.

In a preferred embodiment, each beam is in the form of a truss having an outer frame member constituting upper and lower chords of the truss, and web elements integrally joined to the outer frame member.

Preferably, the web elements and outer frame member define a plurality of substantially triangular apertures.

Preferably, the material of which the core is formed extends through the apertures.

Preferably, each beam has an operational position and includes a central span portion having an upper chord and two end portions extending away from said upper chord.

In a preferred embodiment, the pallet has a pallet operational position and a load support platform which includes said lower support surface, for supporting a load when the pallet is in said pallet operational position, and two side leg portions extending downwards relative to the load support platform when the pallet is in the pallet operational position, wherein the core includes a platform portion and side leg portions which are complementary to the load support platform and leg portions of the pallet respectively, wherein the end portion of each beam extends into a respective one of the side leg portions of the core.

### BRIEF DESCRIPTION OF THE DRAWINGS

Preferred embodiments of the invention will now be described, by way of example only, with reference to the accompanying drawings in which:

FIG. 1 is a perspective view from above of a pallet according to an embodiment of the invention;

FIG. 2 is a plan view of the pallet of FIG. 1;

FIG. 3 is a bottom view of the pallet of FIG. 1;

FIG. 4 is a side view of the pallet of FIG. 1;

FIG. 5 is a front view of the pallet of FIG. 1;

FIG. 6 is a perspective view of an upper shell component of the pallet of FIG. 1;

FIG. 7 is a perspective view of an inner core of the pallet of FIG. 1;

FIG. 8 is a perspective view of a lower shell component of the pallet of FIG. 1;

FIG. 9 is a schematic front view corresponding to FIG. 5 of the pallet, with the pallet shown in a vacuum envelope;

FIG. 10 is a plan view of a seam-fusing machine with the pallet of FIG. 1 mounted thereon;

FIG. 10A is a plan view of a seam-fusing machine according to a different embodiment to that shown in FIG. 10, with the pallet of FIG. 1 mounted thereon;

FIG. 11 is a schematic section view along lines A-A of a part of the pallet as shown in FIG. 2;

FIG. 12 is a schematic perspective view of a reinforcement beam according to an embodiment of the invention;

FIG. 12A is a schematic perspective view of a reinforcement beam according to an embodiment of the invention different to the embodiment of FIG. 12;

FIG. 12B is a front view of the pallet partly cut away to show a leg reinforcement element according to the embodiment of FIG. 12A;

FIG. 13 is a lower perspective view of a pallet according to an embodiment of the invention different to the embodiment of FIG. 1;

FIG. 14 is an upper perspective view of the pallet of FIG. 13;

FIG. 15 is a front view of the pallet of FIG. 13;

FIG. 16 is a cross-section through the pallet of FIG. 13 along the lines B-B in FIG. 14;

FIG. 17 is an enlarged view of a portion of FIG. 16 identified by a dashed border;

FIG. 18 is a side view of the pallet of FIG. 13;

FIG. 19 is a bottom view of the pallet of FIG. 13;

FIG. 20 is a top view of the pallet of FIG. 13;

FIG. 21 is a perspective view of a reinforcement bar of the pallet of FIG. 13;

FIG. 22 is a cross-section through the reinforcement bar of FIG. 21;

FIG. 23 is a schematic side view of the pallet of FIG. 13 and a pallet truck;

FIG. 24 is a schematic perspective view of a tine sheath according to an embodiment of the invention;

FIG. 25 is a schematic perspective view of a rib forming part of a reinforcement frame according to an embodiment of the invention;

FIG. 26 is a schematic front view of the rib of FIG. 25;

FIG. 27 is a schematic top view of the rib of FIG. 25;

FIG. 28 is a schematic perspective view of a side support forming part of the reinforcement frame, according to the embodiment of the invention of FIG. 25;

FIG. 29 is a schematic front view of the side support of FIG. 28;

FIG. 30 is a schematic top view of the side support of FIG. 28;

FIG. 31 is a schematic perspective view of a pallet according to the embodiment of the invention of FIG. 25;

FIG. 32 is a schematic top view of the pallet of FIG. 31;

FIG. 33 is a schematic front view of the pallet of FIG. 31 with the pallet supported on a floor surface;

FIG. 34 is a schematic front view of the pallet of FIG. 31 with the pallet supported on drive through racking;

FIG. 35 is a schematic front view of an end portion of a rib according to a different embodiment to the rib of FIG. 25;

FIG. 36 is an enlarged view of the a part of the end portion of FIG. 35 with the side supports not shown;

FIG. 37 is a schematic front view of a beam according to another embodiment of the invention;

FIG. 38 is an end view of the beam of FIG. 37;

FIG. 39 is a cross-section along the line C-C in FIG. 37;

FIG. 40 is a cross-section along the line D-D in FIG. 37; and

FIG. 41 is a schematic view showing locking clip formations of upper and lower core covering shell components.

### DETAILED DESCRIPTION

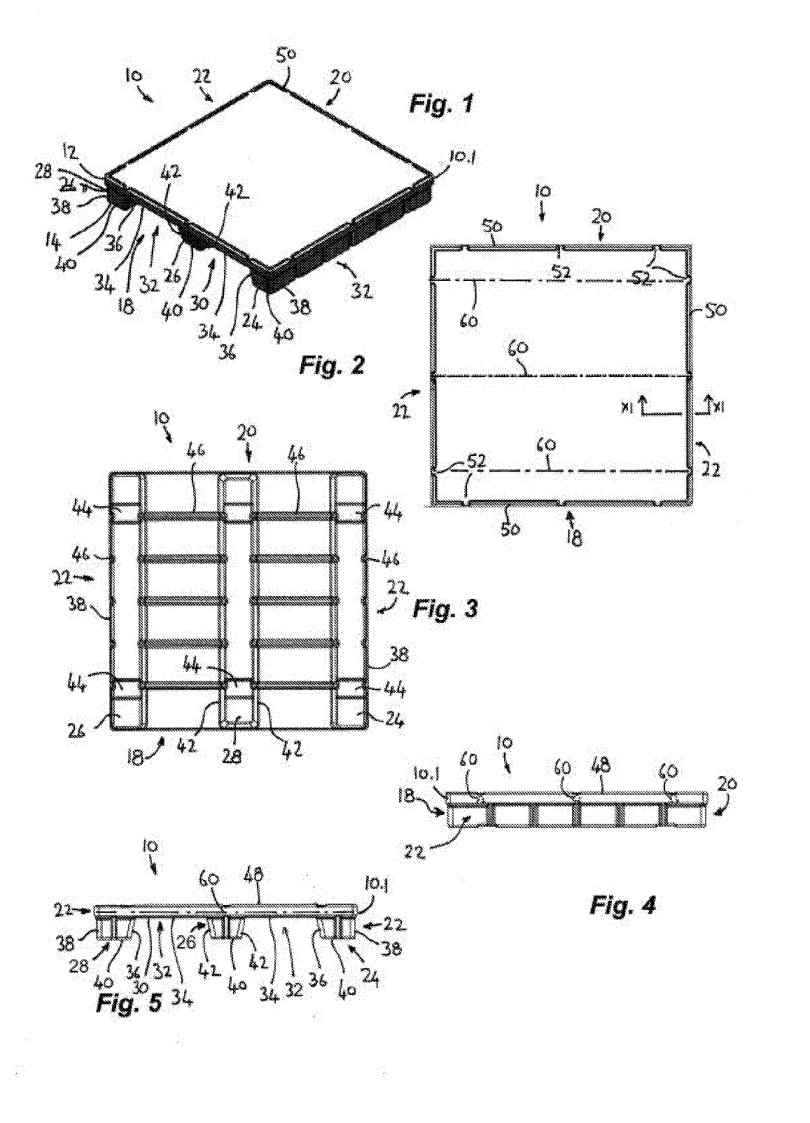

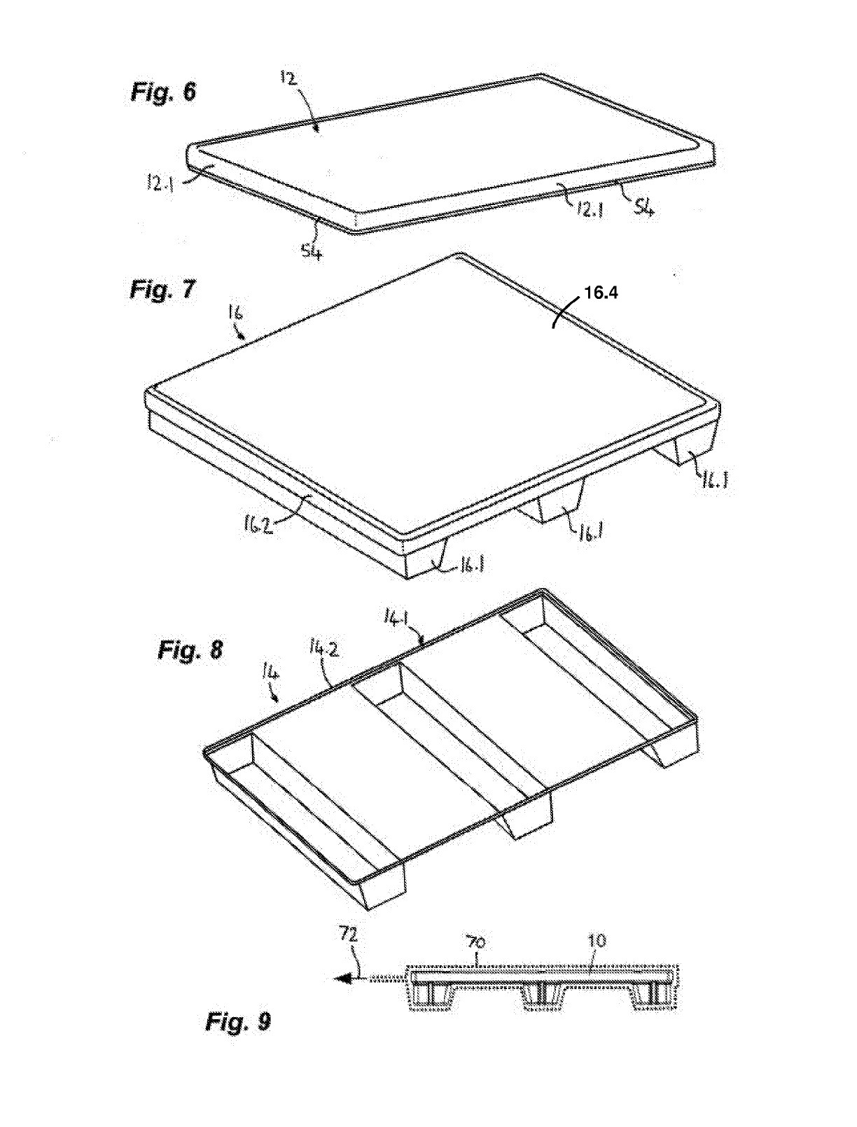

Referring to FIGS. 1 to 12B, there is a shown a pallet 10. The pallet 10 includes an upper shell component 12, a lower shell component 14 and an inner core 16, and has a front side 18, rear side 20 and two lateral sides 22. The overall outer shape of the pallet 10 is essentially defined by the inner core 16, with the upper and lower shell components 12, 14 being of complementary shape to the inner core.

The pallet 10 has a first leg portion 24, a second, middle leg portion 26 and a third leg portion 28, each leg portion extending between the front and rear sides 18, 20 of the pallet. Between the first and second leg portions 24, 26, there is a first under-pallet space 32, and between the second and third leg portions 26, 28, there is a second under-pallet space 32, with under surface portions 34 of the pallet facing into those spaces.

The under-pallet spaces 32 are for accommodating tines of pallet moving vehicles such as pallet trucks and forklift trucks. Thus, these spaces 32 may be regarded as tine spaces.

While each leg portion 24, 26, 28 is shown in the figures to extend from the front side 18 to the rear side 20 of the pallet, in another embodiment, each leg portion may instead be constituted by separate (for example, three) leg portion parts.

The inner core 16 has leg portions 16.1 which, together with the corresponding portions of the upper and lower shell components 12, 14 constitute the leg portions 24, 26, 28.

The portion 10.1 of the pallet 10 above the leg portions 24, 26, 28 is a support portion (load support portion), and the inner core 16 has a corresponding support portion 16.2. The support portion 16.2 of the inner core 16 includes a recess 16.3 extending around its perimeter. Thus, the support portion 10.1 of the pallet 10 as a whole includes a corresponding recess 10.2 (see FIG. 11). The core 16 also has an upper load support face 16.4.

Each of the first and third leg portions 24, 28 has a first, inner wall 36 facing into the respective, adjacent under-pallet space 32, and an opposite, second, outer wall 38, and has a lower surface 40 on which the pallet 10 can be seated on a floor or other substrate (not shown).

The middle leg portion 26 has two opposite side walls 42 and a lower surface 40 aligned with the lower surfaces 40 of the first and third leg portions 24, 28.

The first walls 36 of the first and third leg potions 24, 28 and the two side walls 42 of the middle leg portion 26 are orientated at an obtuse angle relative to the lower surfaces 40. The two outer walls 38 are substantially at right angles relative to the lower surfaces 40.

Towards the front side 18 and rear side 20 of the pallet 10, each leg portion 24, 26, 28 is provided with a seating recess 44.

In addition, along an outer surface of each leg portion 24, 26, 28 and each under surface portion 34 of the pallet 10, there are provided a series of grooves 46, the grooves on the leg portions being aligned with those on the under surface portions. The curved surface area provided by the grooves 46 may assist in contributing to strength.

The upper load support surface 48 of the pallet 10 is a substantially flat surface.

The pallet 10 can be used to support a load, and can be moved from place to place by means of a pallet truck or forklift truck.

The pallet 10 can be stored on a pallet rack (not shown). One type of rack on which it can be placed is a drive-in rack, having two spaced-apart rails for supporting the first and third leg portions 24, 28.

Alternatively, the pallet 10 can be placed on a rack having rails which extend transversely with respect to the direction from the front side 18 to the rear side 20 of the pallet (i.e. extending in the direction from one lateral side 22 to the other). In this case, the pallet 10 can be lowered onto the rack and be positioned so that the rails are accommodated in the seating recesses 44. This can facilitate proper positioning of the pallet 10 and assist the operator of a forklift truck in avoiding positioning the pallet too far back relative to the rack, which might involve a risk of the pallet falling off the rear of the rack.

What follows is an explanation relating to the manufacture of the pallet 10 according to an embodiment of the invention.

The upper shell component 12 and lower shell component 14 are each in the form of a thin plastic skin. According to one embodiment, each skin is manufactured by co-extruding one plastics material with another plastics material (the separate materials not being shown), so that these two materials are superimposed on each other.

According to one preferred embodiment, the inner plastics material is High Density Polyethylene (HDPE) or ABS and constitutes about 70% of the thickness of the relevant shell component 12, 14, and the outer plastics material is Thermoplastic Olefin (TPO) and constitutes about 30% of the thickness of the relevant shell component.

According to another embodiment, the outer plastics material is Thermoplastic polyurethane (TPU). In this case, in the preferred embodiment, the ABS or HDPE constitutes about 85% of the thickness of the relevant shell component and the TPU constitutes about 15% of the thickness of the relevant shell component.

According to one embodiment, each of the upper shell component 12 and lower shell component 14 is formed to the desired shape by means of a thermo-forming machine (not shown), using a mould (also not shown) having a shape substantially the same as that portion of the inner core to which the respective shell component is to be fitted.

According to another preferred embodiment, the upper shell component 12 and lower shell component 14 are manufactured by co-injection moulding one of the types of plastics materials with the other type of plastics material (the separate materials not being shown).

According to one embodiment, the upper shell component 12 is formed with an additional skirt portion 54 around its perimeter. A perimetral portion 14.1 of the lower shell component 14 adjacent to the component's upper free edge 14.2 is configured to be accommodated in the recess 16.3 of the inner core 16. In addition, the skirt portion 54 of the upper shell component 12 is positioned inwardly relative to a portion 12.1 of the upper shell component extending around the support portion 16.2 of the inner core (see FIG. 11).

According to a preferred embodiment, the skirt portion has a width (vertical extent as shown in FIG. 11) in the range from 30 mm to 40 mm to allow for sufficient overlap with the perimetral portion 14.1 of the lower shell component 14. In addition, the depth of the recess 16.3 is in the range from 5 mm to 10 mm.

This configuration is provided to enable the upper and lower shell components 12, 14 to be joined to each other as discussed further, below.

According to another embodiment, also discussed further below, attachment formations are provided to join the upper and lower shell components 12, 14 to each other.

The inner core 16 is made of expanded polystyrene (EPS) having a density in the range from 20 g/l to 30 g/l.

Referring to FIGS. 12 to 12B, embedded in the core are a plurality of reinforcement beams 60. The embedding of the beams 60 is carried out during a moulding process in which the inner core 16 is formed. The positions of the beams 60 are indicated in dashed lines (as hidden detail) in FIGS. 2, 4 and 5. While three beams 60 are shown, there could be other numbers of beams, for example, seven.

According to one preferred embodiment, each beam 60 includes an upper chord 62, two lower chords 64, and web elements 66 interconnecting the upper and lower chords as illustrated in FIG. 12. As can be seen, groups 66.1 of web elements 66, each consisting of three web elements, are provided at spaced-apart positions along the length of each beam 60, each group of web elements interconnecting the upper and lower chords 62, 64, and being in a triangular configuration.

According to another preferred embodiment as shown in FIGS. 12A and 12B, each beam 60 has three lower bars 64 one of which is centrally located between the other two. In addition, in each group 66.1, there is a vertical web element 66.2 interconnecting the upper chord 62 with the central lower chord 64.

In addition, disposed below some of the groups 66.1 of this beam 60 are leg reinforcement elements 67 which are integrally joined to the beam and which extend vertically downwards from the lowermost horizontal web elements 66 of those groups.

Each leg reinforcement element 67 includes a pair of vertical, side element members 67.1 and horizontal element members 67.2 interconnecting the vertical element members.

When the beams 60 are formed in the inner core 16, the EPS material of the core flows between the upper and lower bars 62 and struts 66, to form a continuous mass. This assists in interlocking the inner core 16 to each beam 60.

In the case of the type of beam shown in FIGS. 12A and 12B, the leg reinforcement elements 67 extend into, and are thus embedded in, the leg portions 24, 26, 28.

In a similar manner to that described in relation to the beam 60, during forming, the EPS material of the core flows between the vertical and horizontal element members 67.1, 67.2 of the leg reinforcement elements 67, to form a continuous mass, to assist in interlocking the leg portions 24, 26, 28 to the leg reinforcement elements 67, as best seen in the cut-away part of FIG. 12B.

To assemble the upper and lower shell components 12, 14 and core 16, according to an embodiment the lower shell component may be placed on a support surface (not shown).

A polyurethane adhesive (not shown) is then applied to an inner surface of the bottom shell component 14, and the inner core 16 can then be placed into the bottom shell component.

According to one embodiment, the bottom shell component 14 and inner core 16 as an assembled unit are then placed or slid into a vacuum envelope 70 as indicated in FIG. 9, but then orientated in an inverted position with the leg portions 24, 26, 28 facing upwards, the vacuum envelope being adapted for use with a vacuum-bagging machine (not shown).

The machine is then used to apply a vacuum to the envelope 70 as indicated by the arrow 72 thereby deflating the envelope into firm engagement with the assembled unit. As this occurs, the envelope 70 takes a form which substantially or largely conforms to the outer shape of the assembled unit. Thus, the envelope 70 applies reasonably evenly distributed inward pressure to the assembled unit, forcing the lower shell component 14 into firm engagement with the inner core 16.

In this manner the envelope 70 serves as a clamp to that assembled unit. This pressure can be maintained for a period of time such as one hour to allow the adhesive time to cure, after which the assembled unit can be removed from the envelope 70.

Polyurethane adhesive can then be applied to inner surface of the upper shell component 12, and this component can then be placed onto the top of the inner core 16. When the upper shell component 12 is placed onto the inner core 16, the skirt portion 54 overlaps the perimetral portion 14.1 of the lower shell component 14.

The upper and lower shell components 12, 14 and inner core 16 in this combined form are referred to herein as a pallet assembly.

The whole pallet assembly is then placed or slid into the vacuum envelope 70 as described above in relation to the bottom shell component 14 and inner core 16, and the process of placing the envelope in the vacuum-bagging machine, applying a vacuum, and allowing time (say one hour) for the adhesive to cure, can then be repeated.

Thus, the envelope 70 takes a form substantially or largely conforming to the outer shape of the pallet assembly, and applies a reasonably evenly distributed inward pressure to the pallet assembly as in the case of the assembled unit mentioned above.

The use of the vacuum envelope 70 and vacuum-bagging machine and the relatively high, and evenly distributed, pressure applied thereby to the assembled unit and pallet assembly assists in avoiding air bubbles between the skin of the upper and lower shell components 12, 14 and inner core 16, once the adhesive dries.

According to a preferred embodiment, the vacuum-bagging machine is able to apply the equivalent of 10,000 kg of evenly distributed pressure to the entire exposed surface of the assembled unit and pallet assembly while the polyurethane adhesive cures.

The above-mentioned curing time assists in establishing a strong bond between each shell component 12, 14 and the inner core 16.

According to an alternative embodiment, instead of using the vacuum envelope 70, pressure is applied to the upper and lower shell components 12, 14 by means of a pressure press (not shown).

According to a preferred embodiment the adhesive:
is adapted to cure in the absence of air (e.g. in a vacuum);
has high handling and bonding strength, making it robust and impact-resistant and providing it with a high peel strength;
has favourable temperature stability behaviour in that it can maintain its bond in both relatively hot and relatively cool conditions;
is solvent-free thus assisting to avoid dissolving of the EPS material of the inner core;
is simple to mix and apply;
has a reasonably short drying time (about 30 to 45 minutes);
has a relatively long functional life; and
does not begin to cure until the pallet assembly (or assembled unit) is formed, placed in the vacuum bag 70, and has pressure applied to it by the vacuum bag or by a pressure press.

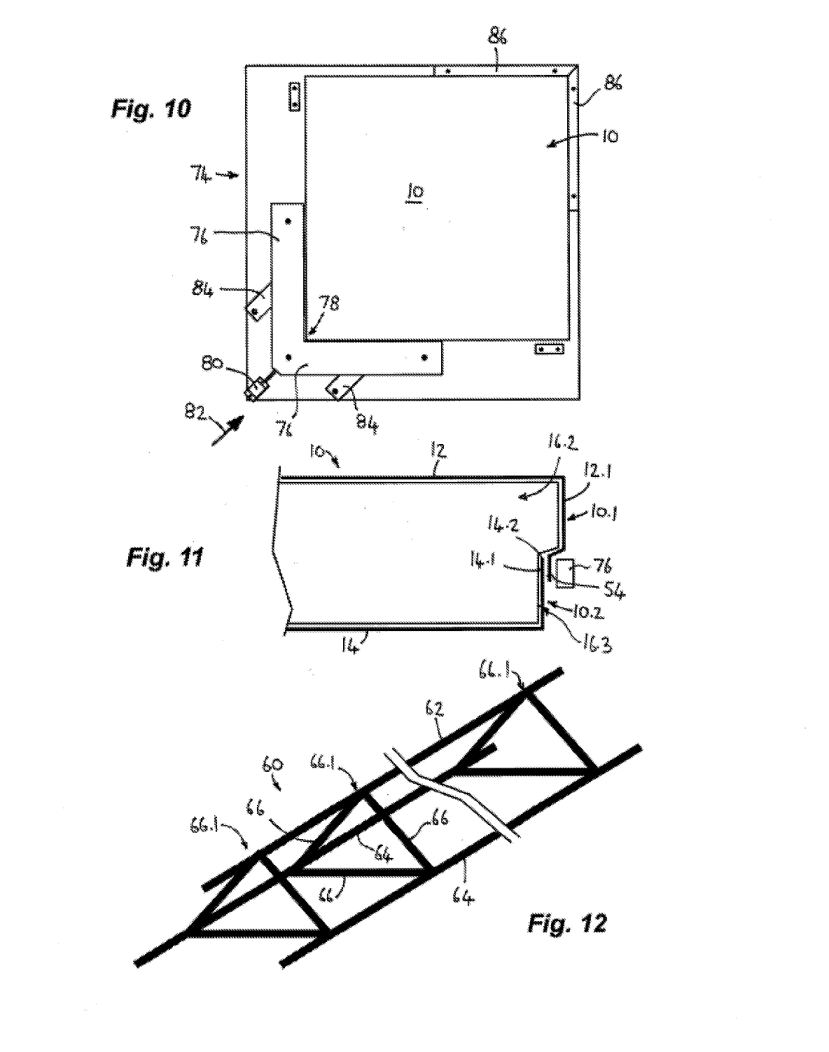

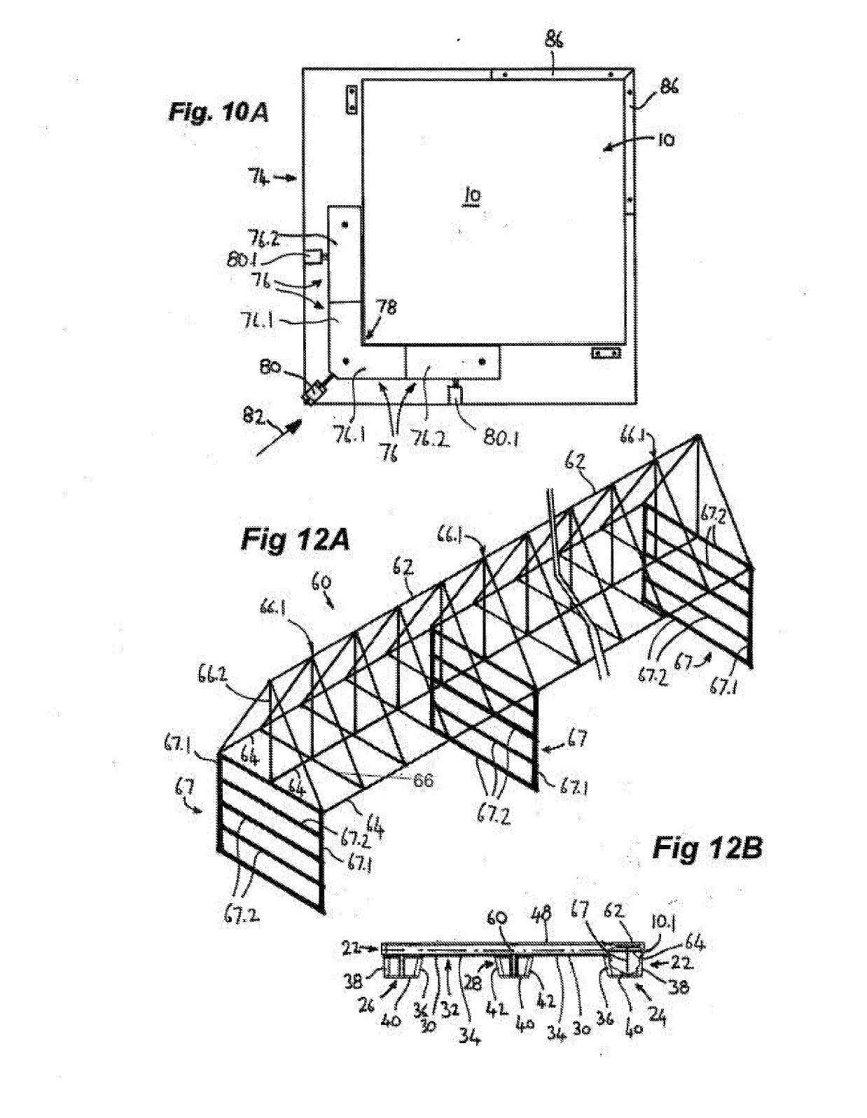

According to an embodiment, the pallet assembly can then be removed from the vacuum envelope 70 or pressure press and placed on a seam-fusing machine 74 (see FIGS. 10 and 10A).

According to one preferred embodiment, the seam-fusing machine 74 includes two arms 76 at right angles to each other and which are joined to each other to form a corner 78, in a substantially L-shaped configuration.

Each arm 76 has a length sufficient to traverse at least half of the length of a side (either the front side 18, rear side 20, or lateral side 22) of the pallet assembly.

The pallet assembly is placed on the seam-fusing machine 74 such that a corner of the pallet assembly is received in the corner 78 formed by the arms 76, with one arm extending along part of a front or rear side of the pallet assembly, while the other arm 76 extends along part of an adjacent side of the pallet assembly.

Joined to the arms 76 is a computer controlled pneumatic piston 80, which is adapted to urge the arms in a direction corresponding to a diagonal of the pallet assembly, as illustrated by the arrow 82. The seam-forming machine 74 includes tracks 84 along which the two arms 76 can slide, in that direction.

According to another preferred embodiment shown in FIG. 10A, each arm 76 consists of two separate parts, namely a central part 76.1, and an outer part 76.2. The central parts 76.1 of the two arms 76 are joined to each other to form the corner 78, as in the embodiment of FIG. 10. Each outer arm part 76.2 is disposed immediately adjacent to a respective central arm part 76.1 and is movable independently of that central part.

Additional computer controlled pneumatic pistons 80.1 are provided for moving the outer arm parts 76.2.

While the piston 80 is adapted to urge the central arm parts 76.1 in a direction corresponding to a diagonal of the pallet assembly as mentioned above, the pistons 80.1 are adapted to urge the respective outer arm parts 76.2 perpendicularly relative to the sides of the pallet assembly along which they are positioned.

Having the central and outer arm parts 76.1, 76.2 independently movable of one another allows for slight variations in the positioning of the arm parts at each of the two adjacent sides of the pallet assembly, to make allowance for slight irregularities in the structure of the assembly.

On the opposite side of the pallet 10 to the arms 76, the seam-forming machine 74 has a pair of braces 86 at right angles to each other. These serve to retain the pallet assembly in place when the arms 76 are urged against it.

When the pallet assembly is in this position relative to the arms 76, the arms are aligned with, and in contact with, the skirt portion 54 of the upper shell portion 12, which in turn overlaps the perimetral portion 14.1 of the lower shell component 14, as shown in FIG. 11.

The arms 76 can then be heated by a heating means such as electric elements running along the arms (not shown) to apply heat to the skirt portion 54.

The EPS material of the inner core 16 has relatively good heat insulation properties. Therefore, as the arms 76 heat up, heat passing through the skirt portion 54 of the upper shell component 12 and perimetral portion 14.1 of the lower shell component 14 is effectively trapped between the inner core 16 and the perimetral portion which overlies, and is in contact with, the inner core.

As this heat is largely prevented from dissipating by the heat insulation properties of the EPS material, this together with the pressure applied by the arms 76, assists in causing the skirt 54 and perimetral portion 14.1 to be heat-fused to each other. Preferably, the width of the overlapping portions of the skirt 54 and perimetral portion 14 is in the range of 10 mm to 15 mm.

Once this process is completed, the pallet assembly can be rotated through 180 degrees so that the corner thereof received in the corner 78 is the diagonally opposite corner to that previously accommodated therein.

The heating process by the arms 76 is then repeated in order to fuse the areas of the skirt 54 and perimetral portion 14.1 that were not heat-fused by the first heating operation.

According to a different embodiment to that involving the use of the seam-fusing machine 74, as mentioned above, in one preferred embodiment the upper and lower shell components 12, 14 are provided with complementary locking clip formations 698 shown schematically in FIG. 41, which are adapted to positively engage one another. Thus, as the upper and lower shell components 12, 14 are urged towards each other to sandwich the core 16 in between, the clip formations 698 on the upper shell component 12 engage corresponding clip formations 698 on the lower shell component 12. These corresponding clip components 698 inter-engage with each other to effectively lock the upper and lower shell components 12, 14 to each other.

The pallet 10 is used to support loads as is the case with conventional pallets.

However, the TPO or TPU material, as the case may be, of the upper and lower shell components 12, 14 has a high co-efficient of friction, and indeed is somewhat sticky to the touch. This assists in preventing loads that are stacked on the pallet 10 from slipping over the surface of the pallet, even if the pallet is tipped to an angle away from the horizontal. On the other hand, the HDPE or ABS material of the other portion of the shell components can contribute to durability.

The recess 16.3 of the inner core 16, and the resultant recessed position of the perimetral portion 14.1 of the lower shell component 14 and skirt portion 54 of the upper shell component 12, assist in protecting the heat-fused joint between those parts. In particular, should the pallet 10 be inadvertently bumped against an object during use, the recessed configuration of those parts can assist in preventing them from engaging that object.

It is typical to stack pallets on pallet-racks (not shown) having spaced-apart support platforms. In the event that the pallet 10 is stacked on such a rack, the reinforcement beams 60 can assist in providing the pallet with structural strength to resist undesirable downward bowing or flexing of the pallet, especially when a load is supported on it.

The right angle between the outer walls 38 and lower surfaces 40 of the first and third leg portions 24, 28 can result in greater areas of those lower surfaces being in contact with, and hence being supported by, the racks (see FIG. 34).

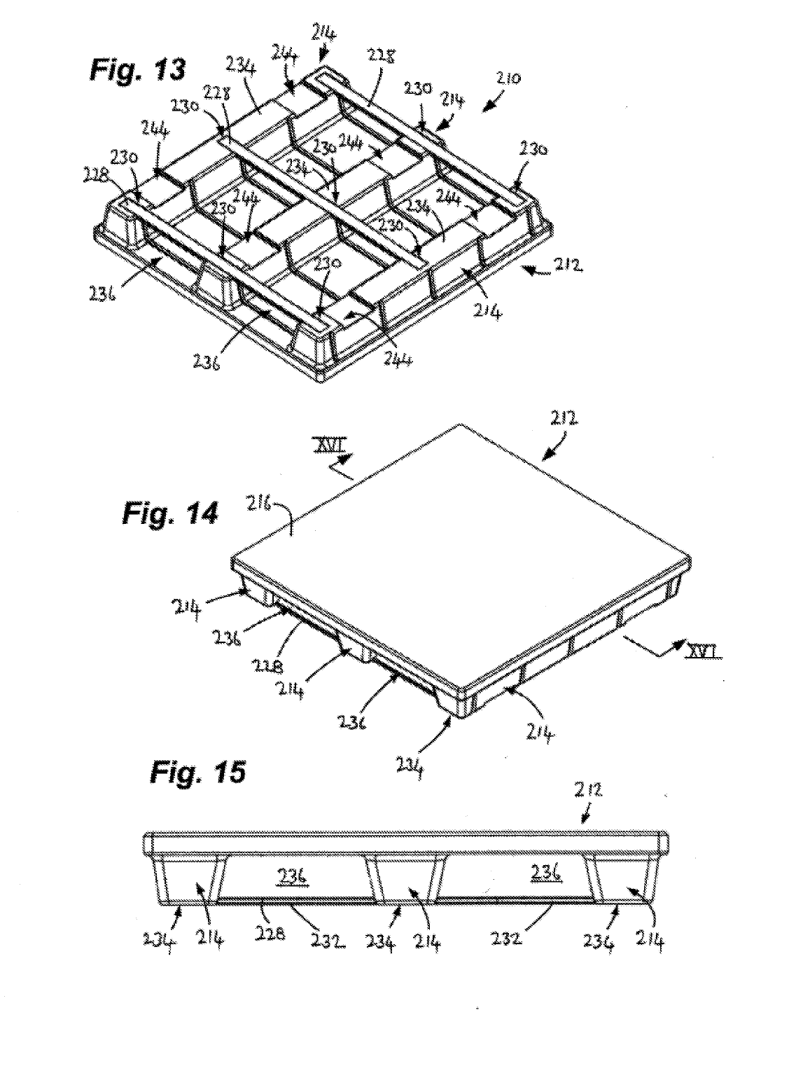

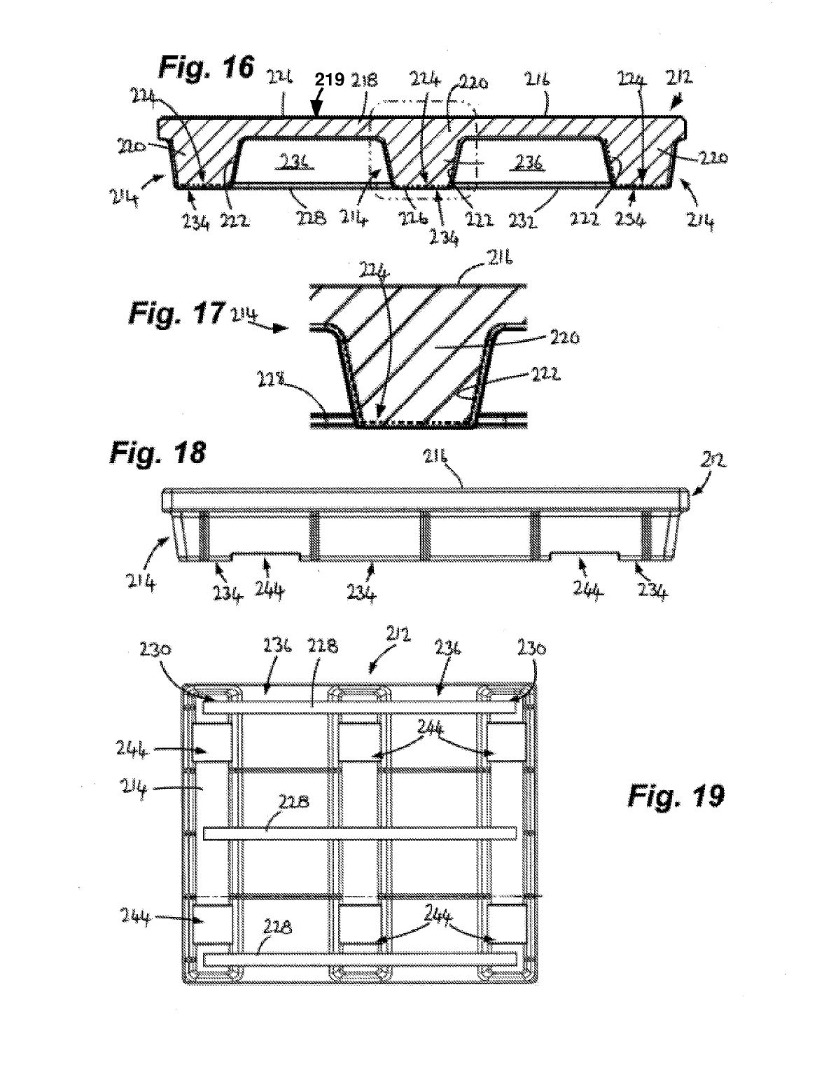

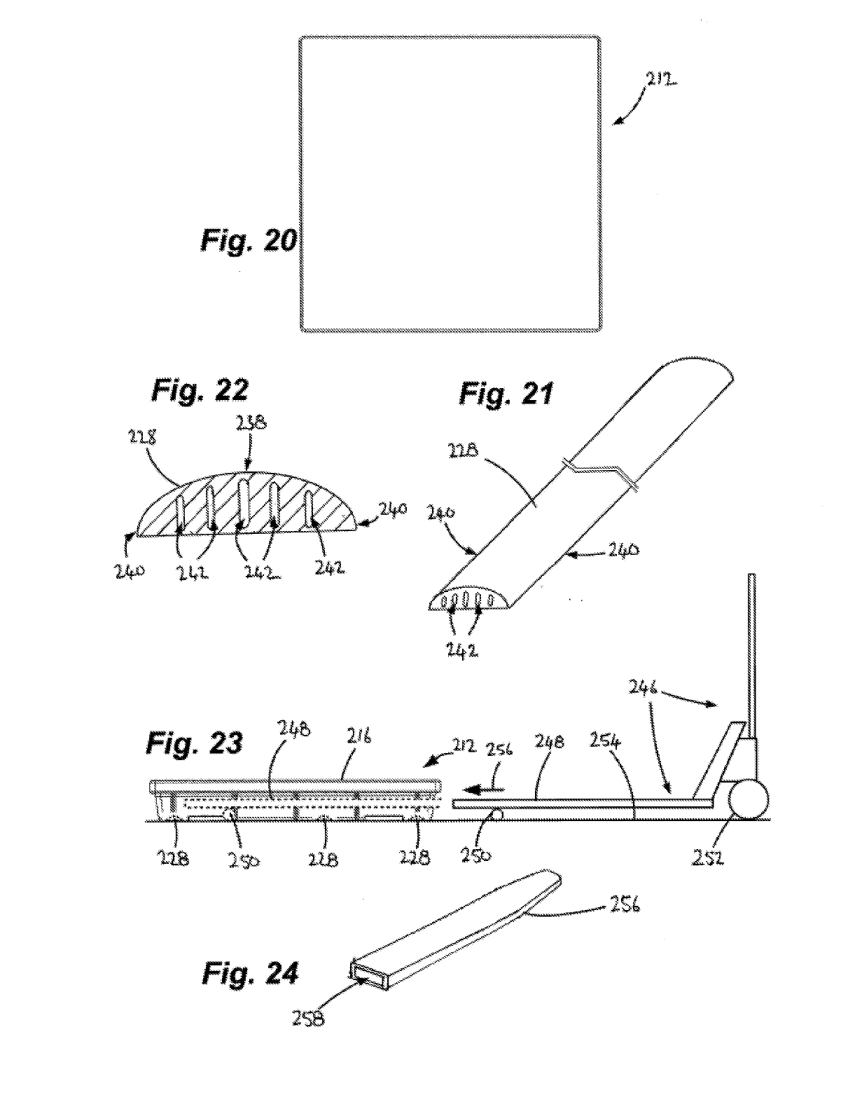

Referring to FIGS. 13 to 24, there is shown a pallet 210 according to a different embodiment to the embodiments of FIGS. 1 to 12B, having a loading formation 212 (load support platform) and leg structures 214. As described in more detail below, the loading formation 212 has a load support surface 216 for supporting a load on the pallet.

The loading formation 212 includes an inner loading formation core 218 while each leg structure 214 includes a leg structure core 220 integral with, and extending from, the loading formation core. The loading formation core 218 and leg structure cores 220 are of expanded polystyrene (EPS).

Each leg structure 214 includes a cap 222, also of HDPE, having a cap interior 224. Each cap 222 is located on the leg structure core 220 of the respective leg structure 214 such that the leg structure core is received in the cap interior 224.

The cap interior 224 of each cap 222 is shaped complementarily with respect to the leg structure core 220 on which it is disposed, such that the cap snugly covers the leg structure core.

The pallet 210 includes an outer skin 226 of formed from co-extruded HDPE and TPO, which covers the loading formation core 218 and caps 222, with the TPO being disposed as an outer surface of the pallet. The loading formation core 218 has an upper load support face 219.

The skin 226 is formed so as to be in contact with these components and conforms to the contours of their outer surfaces. In one embodiment, the leg structure cores 220 are recessed to accommodate the thickness of the caps 222. Thus, the skin 226 where it covers the intersection between the caps 222 and the remainder of the leg structure cores 222 can be smooth and need not be stepped onto the caps.

The portion of the skin 226 covering the loading formation core 218 together with that core constitute the loading formation 212, while the leg structure cores 220, caps 222, and portion of the skin 226 covering the caps, together constitute the leg structures 214.

The pallet 210 includes reinforcement bars 228. Each leg structure 214 has recesses 230 for accommodating portions of the reinforcement bars 228. The reinforcement bars 228 are retained in the recesses 230 by frictional engagement, and in this manner are secured to the leg structures 214.

The recesses 230 are disposed such that when the reinforcement bars 228 are accommodated in the recesses, lower surfaces 232 of the bars are flush with lower support extremities 234 of the leg structures 214.

The leg structures 214 are spaced apart from one another so that there are spaces 236 between them. As discussed in more detail below, these spaces 236 are for accommodating tines of pallet trucks or forklift trucks. Thus, these spaces 236 are referred to below as tine spaces.

The reinforcement bars 228 extend across the tine spaces 236.

Each reinforcement bar 228 has a cross-sectional shape such that the bar tapers from a centre 238 of the cross-section towards outer edges 240 of the cross-section as best seen in FIGS. 21 and 22.

Each reinforcement bar 228 further has inner passages 242 extending substantially the length of the bar. As can be seen in FIGS. 21 and 22, each passage 242 itself is oblong in cross-section with the oblong being orientated vertically.

Each leg structure 214 has locating recesses 244.

The pallet 210 can be used to support a load, and can be moved from place to place by means of a pallet truck 246, illustrated schematically in FIG. 23 or a forklift truck.

As in conventional pallet trucks, the pallet truck 246 includes tines 248, front wheels 250 supporting the tines and rear wheels 252.

The pallet truck 246 can be used by positioning the tines 248 in the spaces 236 of the pallet 210. The tines 248 can be raised to lift the pallet 210 from a substrate in the form of a ground surface 254, on which the pallet is supported, whereupon the pallet can be moved to another location by wheeling the pallet truck.

As the tines 248 are moved into position in the spaces 236 as shown in phantom lines in FIG. 23, the front wheels 250 will be required to roll over the reinforcement bars 228.

The tapered cross-sectional shape of the reinforcement bars 228 facilitates the rolling of the front wheels 250 over the bars.

If the pallet 210 is to be moved by a forklift truck instead of a pallet truck 246, then the tines of the forklift truck can be similarly positioned and lifted to lift the pallet 210 in order to move it to another location.

When the forklift truck and pallet 210 have reached the new location, the pallet can be deposited on a pallet rack (not shown). This can be achieved by raising the pallet 210 to a level somewhat higher than the level of the rack, moving the pallet 210 over the rack, and then lowering the pallet onto the rack before withdrawing the forklift truck.

A typical pallet rack has rails running cross-wise relative to the direction in which the forklift truck moves the pallet 210 over the rack. As the pallet 210 is lowered onto the rack, it can be positioned so that the rails are accommodated in the locating recesses 244. This can facilitate proper positioning of the pallet 210 and assist the operator of the forklift truck in avoiding positioning the pallet too far back relative to the rack, which might involve a risk of the pallet falling off the rear of the rack. It can also assist in allowing the weight of the load on the pallet 210 to be evenly distributed in a front-rear direction on the rack.

As the operator of the forklift truck attempts to move the fork tines of the forklift truck into position in the spaces 236, there is a risk of the tines colliding with the leg structures 214 of the pallet 210. The tines are typically of steel and therefore significantly harder than the leg structures 214. Thus, such a collision can result in the tines piercing the leg structures 214 thereby damaging them and possibly rendering the pallet no longer useable. In addition, metal tines are also likely to damage packaging supported on the pallet 210 such as boxes, and hence also the contents of the packaging, and this can necessitate return of the damaged contents. However, the presence of the caps 222 can add significant strength to the leg structures 214 to reduce the likelihood of the tines piercing them. Indeed, providing the caps 222 can significantly increase the likelihood that if the tines collide with the leg structures 214, this will simply cause the pallet 210 as a whole to be moved by the tines.

To further protect the leg structures 214 and loads, the tines (whether of the pallet truck 246 of a forklift truck) may be provided with protective sheaths 256 as shown in FIG. 24. Each sheath 256 has an inner cavity 258 shaped complementarily with respect to the tine on which it is to be placed. According to a preferred embodiment, the sheaths are of HDPE material.

The sheaths 256 can be retained in place on the tines with suitable attachment means, for example studs on the tines and corresponding apertures in the sheaths (the studs and apertures not being shown), the studs being configured to snap in place in the apertures as the sheaths are pushed onto the tines. The flexibility of the sheaths 256 will allow them to be deformed slightly to remove the studs from the apertures to allow the sheaths to be removed from the tines. Alternatively, other suitable attachment means might be used instead of the studs and apertures as described.

As the sheaths 256 are of plastics material, the likelihood of damage to the leg structures 214, or the extent of damage to those structures, may be reduced in the event of collision of the tines with those leg structures.

The presence of the skin 226 can also add to the strength or toughness of the pallet 210 as a whole, to reduce the risk of damage to the pallet that might exist in the absence of the skin.

The reinforcement bars 228 can contribute to the strength and stiffness of the pallet 210, and in particular the loading formation. This can be particularly beneficial when the pallet 210 is lifted by the pallet truck 246 or a forklift truck, as the weight of the pallet and the load supported by the pallet will in that event be distributed only over the two tines 236 of the vehicle, rather than more broadly distributed over the three leg structures 214 when the pallet is resting, say, on the ground surface 254.

The presence of the passages 242 can also contribute to the strength of the reinforcement bars 228 as compared with other relevant bars not having such passages, or at least may contribute to a favourable strength to weight ratio.

The material of the skin 226 can also facilitate favourable frictional engagement between the loading surface 216 of the pallet 210 and loads such as goods contained in cardboard boxes, supported on the pallet.

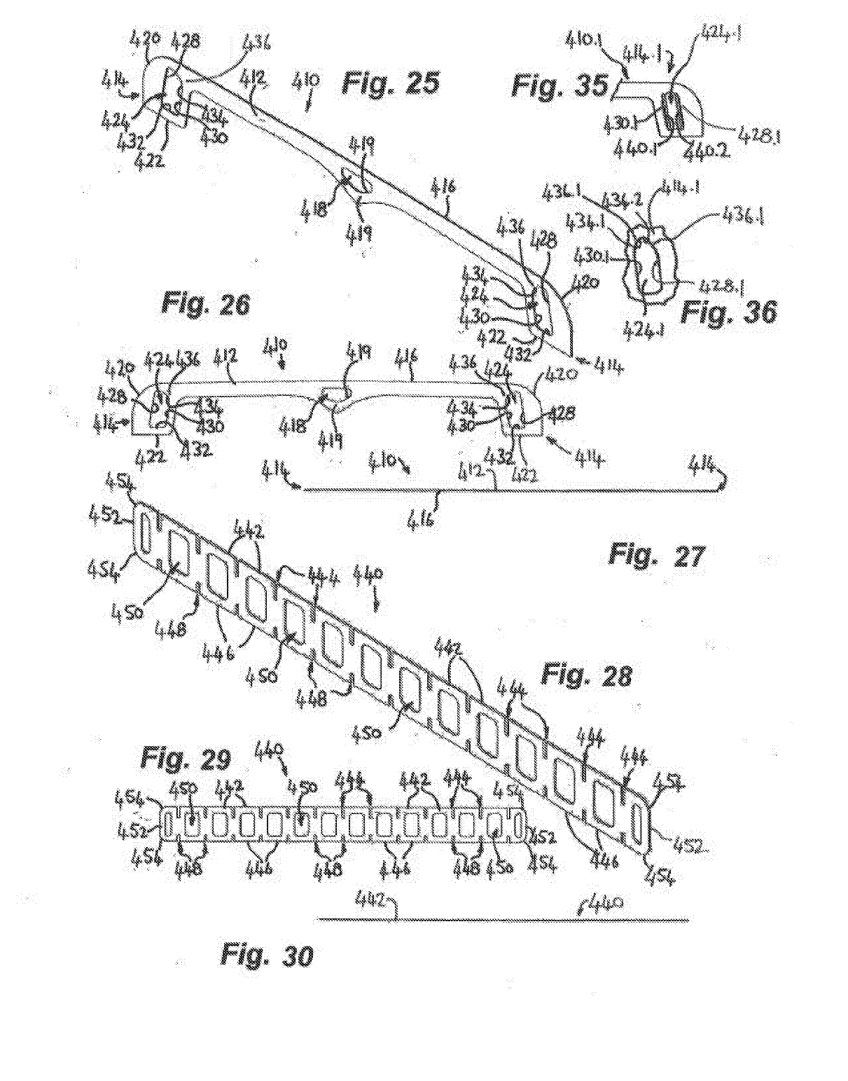

Referring to FIGS. 25 to 27 and 35, there is shown a rib 410 constituting a beam, which forms part of a reinforcement frame for use in a pallet of a different embodiment to those described above.

The rib 410 includes an upper span portion 412 and two end portions 414. The upper span portion 412 is slightly convex in an upwards direction. The span portion 412 includes an upper edge 416, and an interlocking formation in the form of an aperture 418. That part of the upper span portion 412 immediately below the aperture 418, and which includes a lower edge of the aperture, is in the form of a downwardly extending inverted peak 419.

Each end portion 414 has an outer curved edge 420, a lower flat edge 422, and an interlocking portion in the form of an aperture 424.

Each aperture 424 is defined by an edge which faces inwardly with respect to the aperture, the edge including a straight outer edge portion 428, a straight inner edge portion 430, and a straight lower edge portion 432. It also includes a curved edge portion 434 interconnecting the outer edge portion 428 and inner edge portion 430.

The curved edge portion 434 curves downwardly from the outer edge portion 428 to the inner edge portion 430 so as to provide a fillet zone 436 adjacent to each aperture 424, and also such that the inner straight edge portion 430 is shorter than the outer straight edge portion 428.

Referring to FIGS. 28 to 30, there is provided a restraint element in the form of a side support 440. The side support 440 has a straight upper edge 442 with a series of downwardly extending upper slots 444, which open out through the upper edge.

In addition, the side support 440 has a straight lower edge 446, with a series of upwardly extending lower slots 448 which open out through the lower edge.

The upper slots 444 are aligned with the lower slots 448, and their lengths are greater than the lengths of the lower slots 448.

The side support 440 also includes a series of interlocking formations in the form of apertures 450.

At the two opposite ends of the side support 440 are vertical end edges 452, with curved edge portions 454 interconnecting the upper edge 442 and lower edge 446 with the end edges 452.

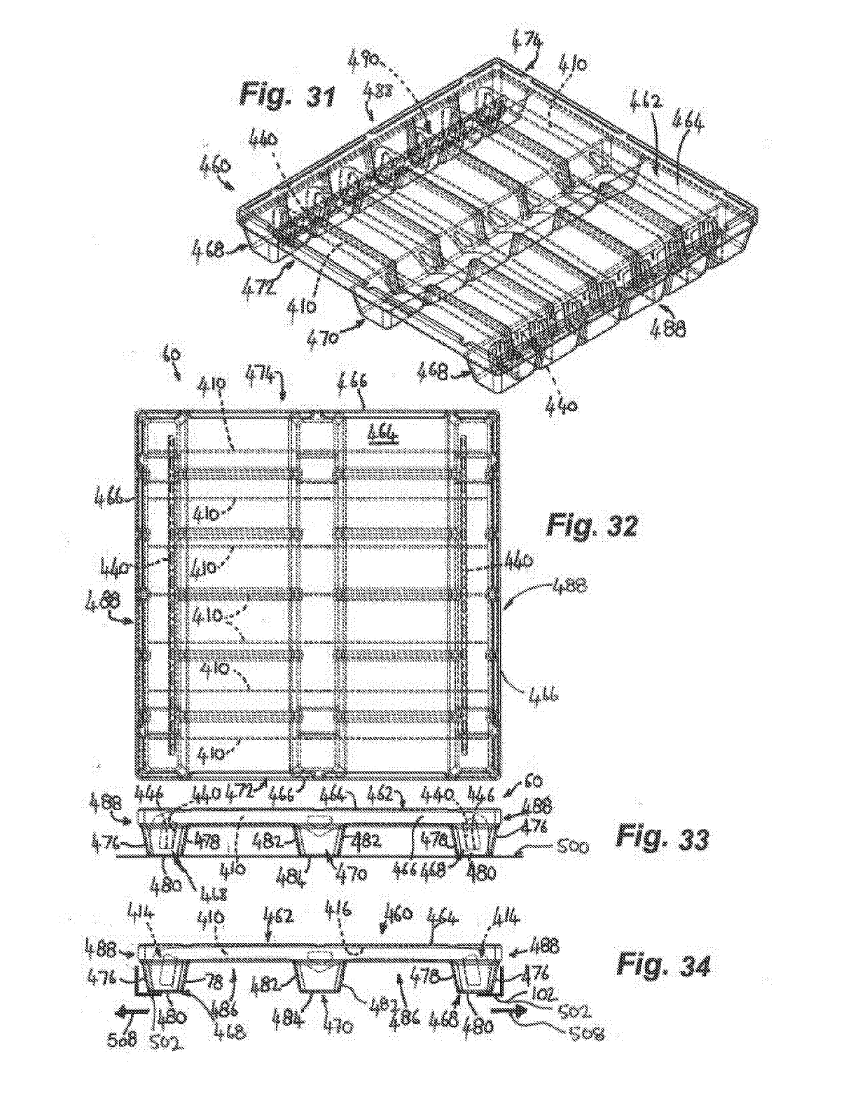

Referring to FIGS. 31, 32 and 33, there is shown a pallet 460, in which there are accommodated (embedded) a number of ribs 410 which extend parallel to one another, in a spaced-apart relationship.

In addition, also accommodated (embedded) within the pallet 460 are a pair of side supports 440, which are engaged with the ribs 410, as described further, below.

According to a preferred embodiment, there are seven ribs 410 which are of injection-moulded, high impact polystyrene (HIPS) as are the side supports 440. The ribs 410 and side supports 440 are each of 10 mm thickness. According to a preferred embodiment, the pallet 460 has an inner core of expanded polystyrene (EPS), and an outer skin.

According to one preferred embodiment the outer skin is of co-extruded high-density polyethylene (HDPE) and thermoplastic polyolefin (TPO) in a ratio of 70% to 30% respectively.

According to another preferred embodiment, the outer skin is of co-extruded acrylonitrile butadiene styrene (ABS) and thermoplastic polyurethane (TPU) in a ratio of 85% to 15% by thickness, respectively. The EPS material of the core and ABS contain “like polymers” which can assists in establishing a bond between the core and skin. Alternatively, similarly to the embodiment described above, while one of the plastics materials is TPU, the other is HDPE, which constitutes about 85% of the thickness of the skin while the TPU constitutes about 15% of the thickness.

The pallet 460 has an upper deck 462 with an upwardly facing horizontal load support surface 464.

The deck 462 has outwardly extending edge walls 466.

The pallet 460 includes two outer leg formations 468 and an inner, middle leg formation 470. The outer and inner leg formations 468, 470 extend substantially the length of the pallet 460, from a front extremity 472 of the pallet to a rear extremity 474 of the pallet.

Each outer leg formation 468 has an outer wall 476 and an inner wall 478, and a pallet support surface 480 facing downwards. The outer and inner walls 476, 478 of each outer leg formation 468 converge on each other in a direction towards the respective pallet support surface 480.

The inner leg formation 470 has two side walls 482, and a downwardly facing pallet support surface 484. The side walls 482, in a similar manner to that of the outer and inner walls 476, 478 of the outer leg formations 468, converge on each other in a downward direction towards the pallet support surface 484 of the inner leg formation 470.

Between each outer leg formation 468 and the inner leg formation 470 there is defined a sub-deck space 486.

The vertical extent (height) of the upper span portion 412 of each rib 410 is slightly less than the thickness of the upper deck 462 of the pallet 460. The upper edge 416 of each rib 410 extends just below the support surface 464, with the end portions 414 of the ribs extending downwards into the outer leg formations 468, as best seen in FIG. 33.

It will thus be understood that each rib 410 extends between opposite side extremities 488 of the pallet 460, most of the way across the width of the pallet.

The pallet 460 is formed in a moulding process with the ribs 410 and side supports 440 embedded within the pallet as described above.

Prior to the moulding process, it is necessary to assemble the ribs 410 with the side supports 440.

As mentioned above, the outer edge portions 428 of the apertures 424 are longer than the inner edge portions 430. The height of each aperture 424 immediately adjacent to the outer edge portion 428 is greater than the height of the side supports 440. However, this is not the case immediately adjacent to the inner edge portion 430, due to the presence of the curved edge portion 434 and fillet zone 436 of each rib 410.

Thus, a side support 440 can be passed through the aperture 424 of a rib 410 if the side support is in close proximity to the outer edge portion 428 of the aperture.

If a number of the ribs 410 are supported in a vertical, parallel relationship as mentioned above, in which the apertures 424 of the ribs are aligned with one another, one side support 440 can be passed through the apertures 424 of the ribs, adjacent one end of each of the ribs, and another side support can be passed through the apertures adjacent the other end of each rib.

The curved edge portions 454 of the side supports 440 facilitate the process of passing the side supports through the aligned apertures 424 of the parallel ribs 410.

When assembling the ribs 410 and side supports 440 in this way, the ribs are supported (in a manner not shown) so as to be spaced apart from one another by the same distance as between successive upper slots 444, and successive lower slots 448 in the side supports 440.

The side supports 440 are positioned so that the end edges 452 of the side supports protrude beyond the two outermost ribs, and such that the upper and lower slots 444, 448 are aligned with the ribs.

Once the side supports 440 are positioned in this manner, each side support can be moved inwardly with respect to the pallet 60, that is, towards the inner leg formation 470, so that the fillet zones 436 of the respective ribs 410 are received in the corresponding upper slots 444 of the side supports.

In addition, as the side supports 440 are moved in this manner, they are also moved downwards, so that the lower edge portions 432 of the apertures 424 are received in the lower slots 448.

Once the ribs 410 and side supports 440 are assembled in this manner, together they constitute a reinforcement frame of the pallet 460, generally referenced 490.

After the reinforcement frame 490 has been assembled, the moulding process can commence, so as to embed the frame 490 within the pallet 460. As this occurs, the plastics material used for moulding the pallet 460 flows through the central aperture 418 and outer apertures 424 of the ribs 410, and the apertures 450 of the side supports 440. Once the plastics material has set and cured, the material that has flowed through the various apertures contributes to the interlocking between the ribs 410 and side supports 440 on the one hand, and the pallet 460 on the other hand.

The pallet 460 is used for supporting loads on the support surface 464. When the pallet 460 is supported on a normal substrate in the form of a floor surface 500 as shown in FIG. 33, the pallet support surfaces 480, 484 of the outer and inner leg formations 468, 470 are supported on the floor 500. This assists in distributing the weight of the load on the pallet 460 evenly between the leg formations 468, 470.

However, an expected common use for such a pallet 460 is on a drive through racking having racks 502 on which areas of the outer leg portions 468 are supported as shown in FIG. 10. It will be appreciated that only the outer leg formations 468 are supported on the racks 502, and not the inner leg formation 470. As a result, the inner leg formation 470 is not supported, and the pallet 460 can therefore suffer from sagging.

However, as mentioned above, the upper span portion 412 of the pallet 460 is upwardly convex. Due to this curvature, a sagging effect caused on the pallet 460, in particular on the upper span portion 412, due to the load supported on the support surface 464, will urge the upper span portion from its upwardly curved configuration into a more straightened, horizontal configuration. This, in turn, has the effect of urging the end portions 414 of the ribs 410 in an outward direction, that is, in the direction of the arrows 508 in FIG. 34.

As the end portions 414 are urged in this manner, due to the engagement of the inner edges 430 of the apertures 424 with the side supports 440, force will also be exerted on the side supports in the direction of those arrows 508.

As the side supports 440 extend transversely with respect to the ribs 410, that is, in a direction from the front 472 to the rear 474 of the pallet 460, the force exerted by the ribs 410 in the directions of the arrows 508 may be distributed along the longitudinal length of the side supports 440, and hence of the outer leg formations 468.

This can assist in minimising deformation of the material of the pallet 460 adjacent to the end portions 414, and thus assist in resisting the urging forces of those end portions in the directions of the arrows 508. This, in turn, can assist in resisting against sagging of the pallet 460.

In addition, the material of the outer part of the skin of the pallet 460 as mentioned above has a relatively high co-efficient of friction. This assists in establishing frictional force between the pallet support surfaces 480 of the outer leg portions 468 and the racks 502 of the drive through racking. This frictional force assists in resisting movement of the outer leg portions 468 in the directions of the arrows 508, and this in turn can assist in resisting sagging of the pallet 460. Indeed, while a heavier load on the pallet support surface 464 is likely to contribute to the tendency of the pallet 460 to sag, such a heavier load will also add to the frictional force between the outer leg portions 468 and the racks 502, which will assist in resisting that increased tendency to sag.

Referring to FIGS. 35 and 36, there is shown an end portion 414.1 of a rib 410.1 according to another embodiment of the invention. While this end portion 414.1 is described in relation to one end of the rib 410.1, the end portion at the other end of the rib is the mirror image, as in the case of the rib 410 of FIGS. 25 and 26.

In this embodiment, instead of the aperture 424 with the curved edge portion 434 shown in FIGS. 25 and 26 interconnecting the outer edge portion 428 and inner edge portion 430, there is an aperture 424.1 with its outer and inner edge portions 428.1, 430.1 connected by a curved portion 434.1 having an apex region 434.2, with two fillet zones 436.1 adjacent that apex region.

This embodiment is configured to accommodate two side supports, being an inner side support 440.1 and an outer side support 440.2, each being of the same shape and size as the side support 440 of FIGS. 28, 29 and 30.

The functionality and means of assembly of the inner side support 440.1 is similar to that of the side support 440. The means of assembly of the outer side support 440.2 is also the same, except that it is disposed adjacent to the outer edge portion 428.1 rather than adjacent to the inner edge portion 430.1.

The functionality of the outer side support 440.2 is the same as that of the inner side support 440.1, but in an opposite direction as described below.

As mentioned above, the upper span portion 412 of the pallet 460 is upwardly convex so that a sagging effect caused on it by a load on the support surface 464 will urge the end portions 414 of the ribs 410 outwardly. The engagement of the inner edges 430 of the apertures 424 with the side supports 440 can thus exert an outward force on the side supports which can be distributed along the longitudinal length of the side supports 440.

If the sagging effect on the upper span portion 412 is sufficient to deform that upper span portion from an upwardly convex configuration to a concave configuration, further sagging will urge the end portions 414.1 of the ribs 410.1 inwardly, rather than outwardly as in the case of the ribs 410. In this event, the engagement of the outer edges 428.1 of the apertures 424.1 with the outer side supports 440.2 can thus exert a force on those side supports which can be distributed along the longitudinal length of those side supports 440.2.

This can assist in minimising deformation of the material of the pallet 460 adjacent to the end portions 414.1, and thus in resisting the urging forces of those end portions in directions opposite the directions of the arrows 108. This, in turn, can assist in resisting against further sagging of the pallet 460.

According to another preferred embodiment, instead of the beams 60, 410 described above, there are provided beams 700 preferably of injection moulded HIPS or alternatively of ABS plastic. As an alternative the beams 700 are of aluminium.

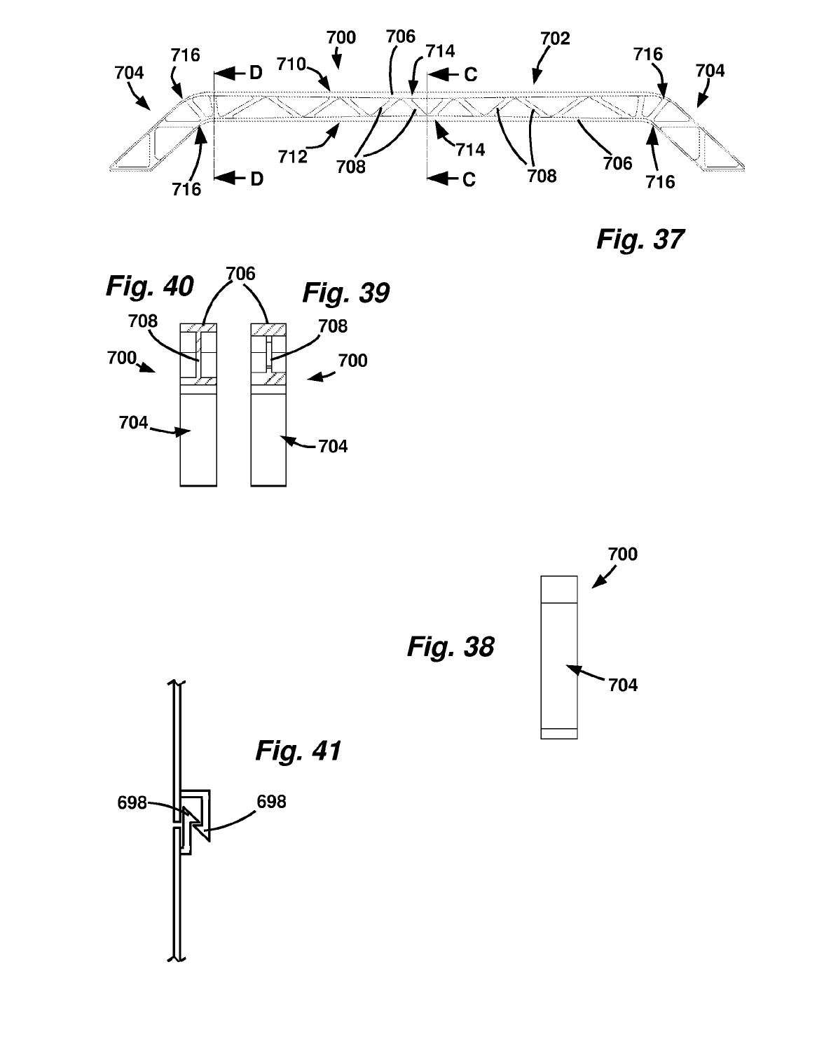

Each beam 700 is in the form of a truss as shown in FIGS. 37 to 40, and has an upper laterally extending portion 702 and two diagonally extending end portions 704.

Each beam 700 is formed as a frame having outer frame parts (chords) 706 and integral, interconnecting web elements 708. The outer frame parts 706 include an upper part 710 extending along the top of the beam 700 and a lower part 712 extending along the bottom of the beam. For each of the upper part 710 and lower part 712, a central area 714 is thicker than outer areas 716 close to the diagonally extending portions 704.

The thicker central areas 714 are for providing greater strength to that area which is expected to be the area subject to the most stress in use, while the thinner outer areas 716 are for saving weight in relation to the beam 700 as a whole. Indeed, according to a preferred embodiment, the beam 700 may be as light as in the order of 640 grams.

The web elements 708 are relatively thin members while the outer frame parts 706 are relatively broad and flat, to produce a cross-section viewed longitudinally along the beam 700 which is similar to that of an I-beam as shown in FIGS. 39 and 40. According to a preferred embodiment, the breadth of the outer frame parts 706 is in the range from 30 mm to 35 mm.

The diagonally extending portions 704 extend into, and are thus embedded in, the leg portions 24, 26, 28 of the pallet 10, or the leg portions 214 of pallet 210 as the case may be.

According to the preferred embodiment, the upper edge 716 of the uppermost frame part 704 is flush with, and therefore visible at, the upper support face 16.4 or 219 of the relevant core 16 or 218.

Because the upper edge 716 of the frame parts 706 of each beam 700 is flush with the upper support face 16.4 or 219 of the relevant core 16 or 218, when the upper shell component 12 or skin 226 is applied to the core as described, the upper edge will be in contact with the inner surface of the upper shell component or skin or any intervening adhesive.

In a similar manner to that described in relation to the beam 60, during forming, the EPS material of the core 16 or 218 flows through openings defined by the outer frame parts 706 and the web elements 708, to form a continuous mass, to assist in interlocking the core 16, 218 to the beams 700.

The configuration and material of each beam 700 assists in providing a favourable balance between saving weight and contributing to strength.

In addition, where adhesive is provided between the shell or skin and core, this can assist in providing strength and minimising relative movement between the shell or skin, and core.

This benefit may be further enhanced by contact between the upper edge 716 of the beams 700 and the adhesive. In this regard, the relatively large width of the frame parts 706 and hence the upper edge 716 provides a relatively large area to be in contact with the adhesive and thus to be subject to this benefit, while the relative thinness of the web elements 708 can assist in saving weight of the pallet.

Where components of the pallet such as the core and beams or ribs are of plastics materials containing similar polymers or constituent materials (such as the styrene in ABS, HIPS and EPS plastics), this may assist in enhancing the bond between such components thereby assisting to reduce relative movement between such components and contributing to the strength of the pallet as a whole.

Although the invention is described above in relation to preferred embodiments, it will be appreciated by those skilled in the art that it is not limited to those embodiments, but may be embodied in many other forms.

For example, while features are disclosed as being present in certain embodiments above, it is to be understood that all features disclosed and described can be present in all of the different embodiments unless otherwise indicated, expressly or by the context.

1. A method of making a pallet having a load support surface, the method including:
providing a pallet inner core having a predetermined outer shape, the core including a load support face;
providing a first shell component of plastics material, at least part of the first shell component having a shape substantially complementary to a first portion of said outer shape;
providing a second shell component of plastics material, at least part of the second shell component having a shape substantially complementary to a second portion of said outer shape;
disposing the first shell component on said core such that the first shell component complementarily fits onto said first portion;
disposing the second shell component on said core such that the second shell component complementarily fits onto said second portion; and
interconnecting the first and second shell components to each other,
wherein a load support part of the outer surface of one of the shell components constitutes said load support surface of the pallet, and extends over said load support face of the core.

2. A method according to claim 1 wherein the step of forming a pallet includes applying an adhesive to at least one of the shell and the core.

3. A method according to claim 2 wherein the adhesive is a polyurethane adhesive.

4. A method according to any one of the preceding claims wherein the steps of disposing the first and second shell components includes causing one of the shell components to overlap the other of the shell components.

5. A method according to claim 4 wherein the step of interconnecting the first and second shell components to each other includes fusing the overlapping parts of the shells to each other.

6. A method according to any one of claims 1 to 4 wherein the step of interconnecting the first and second shell components to each other includes engaging locking formations of one of the shell components with locking formations on the other of the shell components.

7. A method according to any one of the preceding claims wherein the method includes forcing the shell components onto the core.

8. A method according to claim 7 wherein the step of forcing the shell components onto the core includes placing the combined shell components and core in an envelope and drawing air from the envelope.

9. A method according to claim 7 wherein the step of forcing the shell components onto the core includes applying pressure using a press apparatus.

10. A method according to any one of the preceding claims wherein the steps of providing the first and second shell components include providing said shell components with each shell component being of a first plastics material and a second, different plastics material joined to the first plastics material.

11. A method according to claim 10 wherein the steps of providing the first and second shell components include co-injection moulding each of the shell components with both of said first and second plastics materials.

12. A method according to claim 10 or claim 11 wherein the first plastics material is Thermoplastic polyurethane (TPU) plastic and the second plastics material is Acrylonitrile butadiene styrene (ABS) plastic, and wherein the first plastics material forms an outer surface of each shell component.

13. A method according to claim 12 wherein the thickness of the first plastics material is 15% of the combined thickness of the first and second plastics materials and the thickness of the second plastics material is 85% of said combined thickness.

14. A method according to any one of the preceding claims wherein the step of providing the inner core includes forming the core by moulding.

15. A method according to claim 14 wherein the step of forming the core includes forming the core with a plurality of reinforcement beams within the core.

16. A method according to claim 15 wherein, in the step of forming the core with a plurality of reinforcement beams within the core, each of the beams is of one of HIPS plastic, ABS plastic, and aluminium.

17. A method according to claim 15 or claim 16 wherein the step of forming the core includes forming the core with an upper edge of each beam flush with said load support face of the core such that, when the particular shell component that includes said load support part is disposed on the pallet, the upper edge of each beam is in contact with at least one of said particular shell component and adhesive between said particular shell component and the core.

18. A method according to any one of claims 15 to 17 wherein, in the step of forming the core with a plurality of reinforcement beams, each beam is in the form of a truss having an outer frame member constituting upper and lower chords of the truss, and integrally joined web elements.

19. A method according to claim 18 wherein the web elements and outer frame member define a plurality of substantially triangular apertures.

20. A method according to claim 19 wherein the material of which the core is formed extends through the apertures.

21. A method according to any one of claims 15 to 20 wherein, in the step of forming the core with a plurality of reinforcement beams, each beam has an operational position and includes a central span portion having an upper chord and two end portions extending away from said upper chord.

22. A method according to claim 21 wherein the method is for forming a pallet having a pallet operational position and a load support platform for supporting a load when the pallet is in said pallet operational position, and two side leg portions extending downwards relative to the load support platform when the pallet is in the pallet operational position, and wherein the core includes a platform portion and side leg portions which are complementary to the load support platform and leg portions of the pallet respectively, wherein in the step of forming the core with a plurality of reinforcement beams, the end portion of each beam extends into a respective one of the side leg portions of the core.

23. A pallet, the pallet including:
a pallet inner core having an outer shape, the core including a load support face;
a first shell component of plastics material, at least part of the first shell component having a shape substantially complementary to a first portion of said outer shape;
a second shell component of plastics material, at least part of the second shell component having a shape substantially complementary to a second portion of said outer shape;
the first shell component being disposed on said core such that the first shell component complementarily fits onto said first portion;
the second shell component being disposed on said core such that the second shell component complementarily fits onto said second portion; and
the first and second shell components are interconnected to each other,
wherein a load support part of the outer surface of one of the shell components constitutes said load support surface of the pallet, and extends over said load support face of the core.

24. A pallet according to claim 23 wherein an adhesive is applied between at least one of the shell components and the core.

25. A pallet according to claim 24 wherein the adhesive is a polyurethane adhesive.

26. A pallet according to any one of claims 23 to 25 wherein one of the shell components overlaps the other of the shell components.

27. A pallet according to claim 26 wherein the overlapping parts of the shells are fused to each other.

28. A pallet according to any one of claims claims 23 to 26 wherein each of the first and second shell components includes locking formations, the locking formations of one of the shell components being engaged with locking formations on the other of the shell components.

29. A pallet according to any one of claims claims 23 to 28 wherein each shell component is of a first plastics material and a second, different plastics material joined to the first plastics material.

30. A pallet according to claim 29 wherein each of the shell components has been co-injection moulded with both of said first and second plastics materials.

31. A pallet according to claim 29 or claim 30 wherein the first plastics material is Thermoplastic polyurethane (TPU) plastic and the second plastics material is Acrylonitrile butadiene styrene (ABS) plastic, wherein the first plastics material forms an outer surface of each shell component.

32. A pallet according to claim 31 wherein the thickness of the first plastics material is 15% of the combined thickness of the first and second plastics materials and the thickness of the second plastics material is 85% of said combined thickness.

33. A pallet according to any one of claims claims 23 to 32 wherein each core is formed with a plurality of reinforcement beams within the core.

34. A pallet according to any claim 33 wherein each of the beams is of one of HIPS plastic, ABS plastic, and aluminium.

35. A pallet according to claim 33 or claim 34 wherein an upper edge of each beam is flush with said load support face of the core such that the upper edge of each beam is in contact with at least one of the particular shell component that includes said load support part and adhesive between said particular shell component and the core.

36. A pallet according to any one of claim 33 or 35 wherein each beam is in the form of a truss having an outer frame member constituting upper and lower chords of the truss, and integrally joined web elements.

37. A pallet according to claim 36 wherein the web elements and outer frame member define a plurality of substantially triangular apertures.

38. A pallet according to claim 37 wherein the material of which the core is formed extends through the apertures.

39. A pallet according to any one of claims 33 to 38 wherein each beam has an operational position and includes a central span portion having an upper chord and two end portions extending away from said upper chord.

40. A pallet according to claim 39 wherein the pallet has a pallet operational position and a load support platform for supporting a load when the pallet is in said pallet operational position, and two side leg portions extending downwards relative to the load support platform when the pallet is in the pallet operational position, and wherein the core includes a platform portion and side leg portions which are complementary to the load support platform and leg portions of the pallet respectively, wherein the end portion of each beam extends into a respective one of the side leg portions of the core.
